(19) United States
(12) Patent Application Publication
(10) Pub. No.: US 2021/0392239 A1
(43) Pub. Date: Dec. 16, 2021

(54) CONTENT REPRODUCTION METHOD, CONTENT REPRODUCTION APPARATUS, AND DISPLAY APPARATUS

(71) Applicant: SEIKO EPSON CORPORATION, Tokyo (JP)

(72) Inventor: Kazuki Nagai, Azumino-shi (JP)

(21) Appl. No.: 17/345,055

(22) Filed: Jun. 11, 2021

(30) Foreign Application Priority Data
Jun. 11, 2020 (JP) 2020-101422

(51) Int. Cl. H04N 5/06; H04N 21/43; H04N 21/434

(52) U.S. Cl. CPC H04N 5/06; H04N 21/4341; H04N 21/4307

(57) ABSTRACT

A content reproduction method for reproducing a content containing voice data and video data includes reading a difference period between the period for which the video data is rendered and the period for which the voice data is rendered from a storage device and adjusting the video data based on a voice reproduction period that is the period for which the voice data is reproduced, a video reproduction period that is the period for which the video data is reproduced, and the difference period in such a way that the video reproduction period synchronizes with the voice reproduction period.

The present application is based on, and claims priority from JP Application Serial Number 2020-101422, filed Jun. 11, 2020, the disclosure of which is hereby incorporated. by reference herein in its entirety.

### BACKGROUND

### 1. Technical Field

The present disclosure relates to a content reproduction method, a content reproduction apparatus, and a display apparatus.

### 2. Related Art

JP-A-2019-125994 discloses a video and voice reproduction apparatus that achieves lip synchronization between video data and voice data by controlling delay periods of the video data and the voice data so as to eliminate the time difference specified from format information between video processing and voice processing.

Adjusting the voice so as to synchronize with the video is likely to be perceptible and can therefore increase discomfort given to the user.

### SUMMARY

An aspect relates to a content reproduction method for reproducing a content containing voice data and video data, the method including reading a difference period between a period for which the video data is rendered and a period for which the voice data is rendered from a storage device and adjusting the video data based on a voice reproduction period that is a period for which the voice data is reproduced, a video reproduction period that is a period for which the video data is reproduced, and the difference period in such a way that the video reproduction period synchronizes with the voice reproduction period.

Another aspect relates to a content reproduction apparatus that reproduces a content containing voice data and video data, the apparatus including a storage device that stores a difference period between a period for which the video data is rendered and a period for which the voice data is rendered and a controller that adjusts the video data based on a voice reproduction period that is a period for which the voice data is reproduced, a video reproduction period that is a period for which the video data is reproduced, and the difference period in such a way that the video reproduction period synchronizes with the voice reproduction period.

Another aspect relates to display device including the content reproduction apparatus described above and a display instrument that displays video images of the content reproduced by the content reproduction apparatus.

### BRIEF DESCRIPTION OF THE DRAWINGS

FIG. 1 is a block diagram for describing a display apparatus according to an embodiment.

FIG. 2 is a flowchart for describing a content reproduction method according to the embodiment.

### DESCRIPTION OF EXEMPLARY EMBODIMENTS

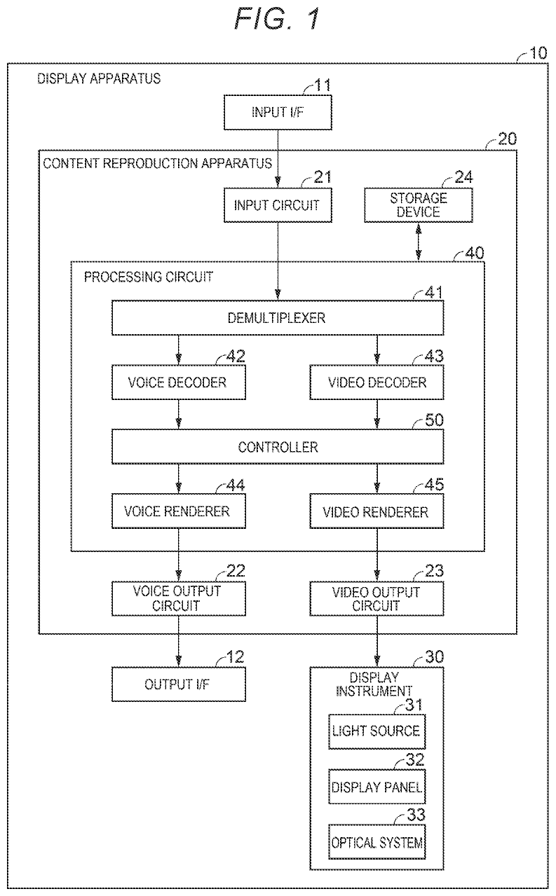

A display apparatus 10 according to an embodiment includes an input interface (I/F) 11, an output I/F 12, a content reproduction apparatus 20, and a display instrument 30, as shown in FIG. 1. In the present embodiment, the display apparatus 10 will be described by way of example as a projector that displays an image by projecting light onto a screen. The display apparatus 10 may, for example, be a flat panel display.

The input I/F 11 receives input of a content from, for example, an external apparatus that is not shown. The content is multimedia data containing time-series voice data and video data. The external apparatus is, for example, a personal computer, a smartphone, a camera, a movie player, a IV tuner, a game console, or any arbitrary apparatus having the function of outputting the content to the display apparatus 10. The input I/F 11 may include, for example, an antenna via which a radio signal is transmitted and received, a connector connected to a communication cable, and a communication circuit that processes the signal delivered over a communication link.

The output I/F 12 outputs a voice signal of the content reproduced by the content reproduction apparatus 20. The output I/F 12 may include, for example, an antenna via which the voice signal is outputted. to another apparatus and a connector. The output I/F 12 may, for example, be a loudspeaker that outputs voice. The output I/F 12 may output a multimedia signal containing a voice signal and a video signal of the content reproduced by the content reproduction apparatus 20.

The display instrument 30 includes, for example, a light source 31, a display panel 32, and an optical system 33. The light source 31 includes a light emitter, for example, a discharge lamp and a solid-state light source. The display panel 32 is a light modulator having a plurality of pixels. The display panel 32 modulates the light outputted from the light source 31 in accordance with the video signal outputted from the content reproduction apparatus 20. The display panel 32 is, for example, a transmissive or reflective liquid crystal light valve. The display panel 32 may instead be a digital micromirror device that controls reflection of the light on a pixel basis. The optical system 33 projects the light successively modulated by the display panel 32 onto the screen to display video images of the content reproduced by the content reproduction apparatus 20. The optical system 33 may include a variety of lenses, mirrors, and other optical elements.

The content reproduction apparatus 20 includes an input circuit 21, a voice output circuit 22, a video output circuit 23, a storage device 24, and a processing circuit 40. The input circuit 21 successively receives input of the content, which is time-series data, from the input I/F 11. The voice output circuit 22 outputs the voice signal of the content reproduced by the processing circuit 40 to the output I/F 12. The video output circuit 23 outputs, for example, the video signal of the content. reproduced by the processing circuit 40 to the display instrument. 30.

The storage device 24 is a computer readable recording medium that stores, for example, a program and a variety of data representing a series of processes necessary for the action of the content reproduction apparatus 20. The storage device 24 can, for example, be a semiconductor memory. The storage device 24 is not limited to a nonvolatile auxiliary storage device and may include a volatile primary storage device. The storage device 24 may be formed of an integrated hardware component or a plurality of separate hardware components.

The processing circuit 40 achieves each function described in the embodiment, for example, by executing a control program stored in the storage device 24. A processing apparatus that forms at least part of the processing circuit 40 can, for example, be any of a variety of logical operation circuits, such as a central processing unit (CPU), a digital signal processor (DSP), a programmable logic device (PLD), and an application specific integrated circuit (ASIC). The processing circuit 40 may be formed of an integrated hardware component or a plurality of separate hardware components.

The processing circuit 40 includes a demultiplexer 41, a voice decoder 42, a video decoder 43, a voice renderer 44,, a video renderer 45, and a controller 50. The processing circuit 40 processes the multimedia data successively inputted via the input circuit 21 and outputs the voice signal and the video signal to reproduce the content. The processing circuit 40 may perform two-dimensional coordinate conversion of the video images, such as keystone correction.

The demultiplexer 41 successively demultiplexes the voice data and the video data from the content inputted from the input circuit 21. The voice decoder 42 decodes the demultiplexed voice data. The video decoder 43 decodes the demultiplexed video data. The voice renderer 44 generates the voice signal by rendering the decoded voice data. The video renderer 45 generates the video signal by rendering the decoded video data.

The controller 50 adjusts the video data to be inputted to the video renderer 45 in such a way that a video reproduction period Tv, which is the period for which the video data is reproduced, synchronizes with a voice reproduction period Ta, which is the per od for which the voice data is reproduced. The controller 50 calculates a voice reproduction period Ta from a sampling rate Rs, at which the decoded voice data is sampled, and the number of samples Ns, which form the decoded voice data. The controller 50 calculates the video reproduction period Tv from a frame rate Rf, at which the decoded video data is sampled, and the number of frames Nf, which form the decoded video data. The calculation of the voice reproduction period Ta and the video reproduction period Tv starts at the same time as the content reproduction starts. The voice reproduction period Ta and the video reproduction period Tv are each successively accumulated.

The controller achieves what is called lip synchronization in which the voice and the video images synchronize with each other by adjusting the video data in such a way that the video reproduction period Tv synchronizes with the voice reproduction period Ta based on the voice reproduction period Ta, the video reproduction period Tv, and a difference period ΔR. The controller 50 reads the difference period AR between the video data rendering period and the voice data rendering period from the storage device 24. The difference period AR is the result of subtraction of the voice data rendering period from the video data rendering period. The voice data rendering period is the period from the start to the end of the rendering performed by the voice renderer 44 at a certain point of time in the voice data. The video data rendering period is the period from the start to the end of the rendering performed by the video renderer 45 at a certain point of time in the video data.

The storage device 24 stores, for example, a difference period AR measured in advance. The difference period ΔR may be a value measured by the controller 50. The storage device 24 may store, for example, a table that records information on the format of at least one of the voice data and the video data in association with the difference period ΔR. When the video data rendering period changes due to the two-dimensional coordinate conversion of the video images, the storage device 24 may store difference periods ΔR that vary due to the two-dimensional coordinate conversion.

The controller 50 calculates a difference D between the video reproduction period Tv and the sum of the voice reproduction period Ta and the difference period ΔR, for example, in response to the input of each frame of the video data. That is, the difference D is determined by Expression (1).

D=(Ta+ΔR)−Tv (1)

When the difference D is greater than a reference value, the controller 50 discards the inputted frame, whereas when the difference D is smaller than the negative number of the reference value, the controller 50 duplicates the inputted frame. The reference value is, for example, a period tf of one frame of the video data. In this process, when D>tf is satisfied, the inputted one frame is discarded, whereas when D<(−tf) is satisfied, the inputted one frame is duplicated. When (−tf)≤D≤tf is satisfied, the inputted one frame is not changed.

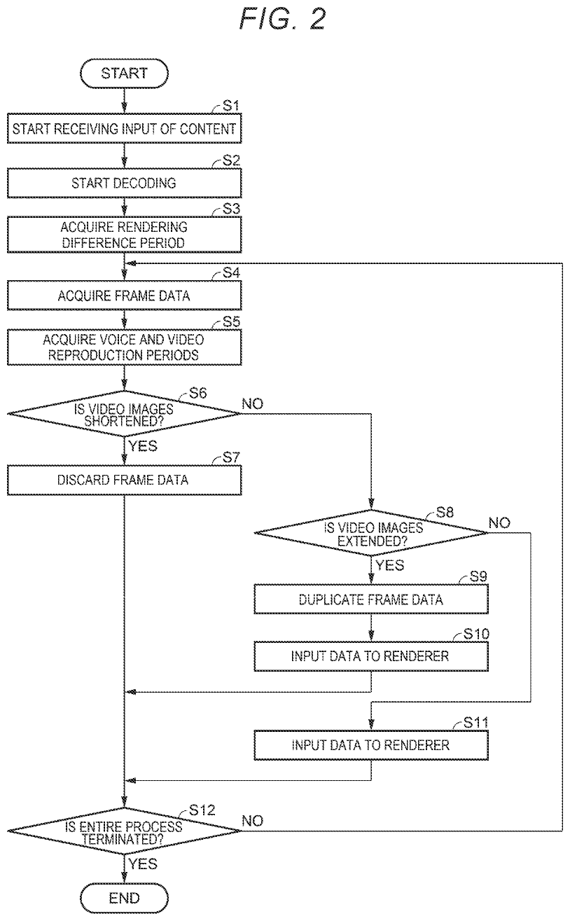

An example of a series of processes carried out by the display apparatus 10 will be described below as a content reproduction method performed by the content reproduction apparatus 20 with reference to the flowchart in FIG. 2.

In step S1, the input circuit 21 starts receiving input of the content from the input I/F 11. In response to the input, the demultiplexer 41 demultiplexes the voice data and the video data from the content inputted by the input circuit 21. In step S2, the voice decoder 42 and the video decoder 43 start the decoding. That is, the voice decoder 42 decodes the demultiplexed voice data, and the video decoder 43 decodes the demultiplexed video data. In step S3, the controller 50 acquires the difference period ΔR between the rendering period for which the video renderer 45 operates and the rendering period for which the voice renderer 44 operates from the storage device 24.

In step S4, the controller 50 acquires, for example, one-frame data in a time series mariner from the video data decoded. by the video decoder 43. In step S5, the controller 50 acquires the voice reproduction period Ta and the video reproduction period Tv. That is, the controller 50 calculates the voice reproduction period Ta from the voice data decoded by the voice decoder 42. Similarly, the controller 50 calculates the video reproduction period Tv from the video data decoded by the video decoder 43.

In step S6, the controller 50 evaluates whether or not to shorten the video images based on the voice reproduction period Ta, the video reproduction period Tv, and the difference period ΔR so that the shortened video images synchronize with the voice. For example, the controller 50 determines to shorten the video images when the difference D between the video reproduction period Tv and the sum. of the video reproduction. period Ta and the difference period ΔR is greater than the reference value, whereas the controller 50 determines not to shorten the video images when the difference D is not greater than the reference value. The controller 50 proceeds to the process in step S7 when the video images are shortened and proceeds to the process in step S8 when the video images are not shortened.

In step S7, the controller 50 adjusts the video data in such a wav that the frame data acquired in step S4 is discarded. The controller 50 omits adding the period corresponding to the frame discarded in step S7 to the video reproduction period Tv.

In step S8, the controller 50 evaluates whether or not to extend the video images based on the voice reproduction period Ta, the video reproduction period Tv, and the difference period ΔR so that the extended video images synchronize with the voice. For example, the controller 50 determines to extend the video images when the difference D between the video reproduction period Tv and the sum of the voice reproduction period Ta and the difference period ΔR is smaller than the negative number of the reference value, whereas the controller 50 determines not to extend the video images when the difference D is not smaller than the negative number of the reference value. The controller 50 proceeds to the process in step S9 when the video images are extended, whereas the controller 50 proceeds to the process in step S11 when the video images are not extended.

In step S9, the video data is so adjusted that the frame data acquired in step S4 is duplicated. That is, in the adjusted video data, the same frame as the frame acquired in step S4 is continuously used twice. The controller 50 adds The period corresponding to the frame duplicated in step S9 to the video reproduction period TV. In step S10, the controller 50 inputs the video data adjusted in step S9 to the video renderer 45.

In step 311, the controller 50 inputs the video data formed of frame data acquired in step 34 to the video renderer 45. In step 312, the controller 50 evaluates whether or not to terminate the entire process in accordance, for example, with a user's operation or the content data. When the result of the evaluation is yes, the controller 50 terminates the entire process, whereas when the result of the evaluation. is no, the controller 50 returns to the process in step S4. In steps S4 to S11, the decoding performed by the voice decoder 42 and the rendering performed by the voice renderer 44 are performed in accordance with the voice data.

As described above, the display apparatus 10 according to the present embodiment can achieve the lip synchronization by adjusting the video data based on the voice reproduction period Ta, the video reproduction period Tv, and the difference period ΔR even when the content has no parameter for lip synchronization. Further, since the video data is so adjusted that the video reproduction period Tv synchronizes with the voice reproduction period Ta, that is, the video data is adjusted with respect to the voice data, the discomfort given to the user with respect to lip synchronization can be reduced as compared with a case where the voice is so adjusted as to synchronize with the video images.

The embodiment has been described above, but the present disclosure is not limited to the disclosed embodiment. The configuration of each portion may be replaced with an arbitrary configuration having the same function, and an arbitrary configuration in the embodiment may be omitted or added within the technical scope of the present disclosure. The disclosure of such replacement, omission, and addition thus allows a person skilled in the art to conceive of a variety of alternative embodiments.

For example, the difference D may be calculated to adjust the video data whenever a predetermined number of frames are inputted. The reference value of the difference D is not necessarily be the period tf of one frame and may instead be the period of a predetermined number of frames. Further, the number of frames to be discarded or duplicated at one time is also not necessarily be one and may instead be two or more.

In addition to the above, the present disclosure, of course, encompasses a variety of embodiments that are not described in the above description, such as a configuration to which the configurations described above are mutually applied. The technical scope of the present disclosure is specified only by the inventive specific items according to the appended claims that are reasonably derived from the above description.

What is claimed is:

1. A content reproduction method for reproducing a content containing voice data and video data, the method comprising:
reading a difference period between a period for which the video data is rendered and a period for which the voice data is rendered from a storage device; and
adjusting the video data based on a voice reproduction period that is a period for which the voice data is reproduced, a video reproduction period that is a period for which the video data is reproduced, and the difference period in such a way that the video reproduction period synchronizes with the voice reproduction period.

2. The content reproduction method according to claim 1, further comprising:
calculating the voice reproduction period from a sampling rate at which the voice data is sampled and the number of samples that forms the voice data;
calculating the video reproduction period from a frame rate and the number of frames of the video data;
calculating a difference between the video reproduction period and a sum of the voice reproduction period and the difference period in accordance with input of a frame of the video data;
discarding the frame when the difference is greater than a reference value; and
duplicating the frame when the difference is smaller than a negative number of the reference value.

3. The content reproduction method according to claim 2, wherein the reference value is a period of one frame of the video data.

4. A content reproduction apparatus that reproduces a content containing voice data and video data, the apparatus comprising:
a storage device that stores a difference period between a period for which the video data is rendered and a period for which the voice data is rendered; and
a controller that adjusts the video data based on a voice reproduction period that is a period for which the voice data is reproduced, a video reproduction period that is a period for which the video data is reproduced, and the difference period in such a way that the video reproduction period synchronizes with the voice reproduction period.

5. A display device comprising:
the content reproduction apparatus according to claim 4; and
a display instrument that displays video images of the content reproduced by the content reproduction apparatus.
